(19) United States
(12) Patent Application Publication
(10) Pub. No.: US 2025/0094312 A1
(43) Pub. Date: Mar. 20, 2025

(54) DATA TRACE INDEXING AND TRACE PACKET ENCAPSULATION

(71) Applicant: Apple Inc., Cupertino, CA (US)

(72) Inventors: Alon YAAKOV, Raanana (IL); Stephan ZEISSET, Portland, OR (US)

(21) Appl. No.: 18/492,685

(22) Filed: Oct. 23, 2023

Related U.S. Application Data
(60) Provisional application No. 63/582,628, filed on Sep. 14, 2023.

(51) Int. Cl. G06F 11/34; G06F 9/30

(52) U.S. Cl. CPC G06F 11/348; G06F 9/30043; G06F 11/3476

(57) ABSTRACT

A system for generating trace packets in a computer system is disclosed. A processor circuit may generate trace information in response to an activation of a trace operation, and a trace circuit, coupled to the processor circuit via a trace interface, may be configured to receive the trace information. The trace circuit may be further configured to generate a plurality of trace packets including a given trace packet that includes an ordered data structure of data sections, wherein an initial data section of the ordered data sections includes a payload, and a final data section of the ordered data sections includes a footer. The trace circuit may be configured, in response to a detection of a load/store instruction in the trace information, to assign a particular index to the load/store instruction from a pool of indices, and generate a data index trace packet using the particular index.

### CROSS-REFERENCE TO RELATED APPLICATIONS

The present application claims the benefit of U.S. Provisional Application No. 63/582,628, entitled “DATA TRACE INDEXING AND TRACE PACKET ENCAPSULATION,” filed Sep. 14, 2023, the content of which is incorporated by reference herein in its entirety for all purposes.

### FIELD

The described embodiments relate generally to computer systems, and more particularly, to techniques for indexing data traces in processor circuits.

### BACKGROUND

Modern computer systems may include multiple circuit blocks designed to perform various functions. For example, such circuit blocks may include processors or processor cores configured to execute software or program instructions. Additionally, the circuit blocks may include memory circuits, mixed-signal circuits, analog circuits, and the like.

Some processors may include circuits that can capture information to aid in the understanding of how a program is executed by the processor. Such information can be used to debug hardware and/or software problems, as well as profiling the performance of a particular program. When execution of a program is traced, a series of packets are created that contain information corresponding to particular events during the execution of the program. For example, a packet may include a copy of data from a load operation. The packets can be asynchronously stored in a memory, bypassing cache memories in the computer system, to be reviewed at a later time.

### BRIEF DESCRIPTION OF THE DRAWINGS

FIG. 1 is a block diagram depicting an embodiment of a processor trace system.

FIG. 2 is a block diagram depicting an embodiment of a processor circuit.

FIG. 3 is a block diagram depicting an embodiment of a trace circuit.

FIG. 4 is a block diagram depicting an embodiment of how trace packets are stored in a trace memory circuit.

FIG. 5 is a block diagram depicting an embodiment of an ordered data structure.

FIG. 6 is a block diagram of an embodiment of a footer field for a trace packet.

FIG. 7 is a flow diagram depicting an embodiment of a method for performing a processor trace.

FIG. 8 is a block diagram depicting another embodiment of processor trace system.

FIG. 9A is a table depicting an embodiment of a data index trace packet.

FIG. 9B is a table depicting an embodiment of a data access trace packet.

FIG. 10 is a flow diagram depicting an embodiment of a method for linking data trace information and instruction trace information.

FIG. 11 is a block diagram of an embodiment of a device that includes a processor trace system.

FIG. 12 is a block diagram of various embodiments of computer systems that may include power management circuits.

FIG. 13 illustrates an example of a non-transitory computer-readable storage medium that stores circuit design information.

### DETAILED DESCRIPTION

Some processor circuits are configured to gather information regarding the execution of various instructions as part of a trace operation. The information gathered during the trace operation can be encapsulated into multiple trace packets that are transferred out of the processor circuit and stored in a trace memory circuit or buffer. Upon completion of the trace operation, the trace packets stored in the memory circuit or buffer can be retrieved by a trace decoder for further processing to examine how the processor circuit executed at least a portion of a program.

Trace packets can include a variety of data that is encapsulated using multiple data sections. For example, a trace packet can include a header and a payload. The header can include information indicative of the length, format, etc., of the trace packet, while the payload includes the actual trace information, such as virtual address information, data to be stored, and the like.

Trace packets are written into the memory circuit or buffer in the order in which they are generated. A pointer into the memory circuit or buffer indicates the where the next trace packet will be stored. When the trace recording is halted, the pointer marks the end of the trace. To decode the stored trace packets, the packets are first examined going forward in the memory circuit or buffer until a delimiter is reached, which notes a synchronization point that can be used as a starting point for a decoder processing the trace recording. Using the synchronization point, the trace packets can be retrieved in the correct order. This process can be time consuming and it requires the use of the delimiter, which is essentially a null packet.

During a trace operation, trace packets may be generated in response to the execution of load instructions and store instructions (collectively “load/store instructions”). A load instruction may generate a data trace packet containing the data retrieved from data memory, while a store instruction may generate a different data trace packet that contains the data to be stored in the data memory along with address information corresponding to the storage location. During the post-processing of the trace information, data trace packets need to be linked to their corresponding load/store instructions.

Load and store instructions may, however, access a data bus in a processor circuit out of order. This out-of-order nature of the data bus access can create a challenge for a decoder processing trace packets to determine a link between load/store instructions and their corresponding data trace packets, leading to errors in post-processing the trace results.

The embodiments illustrated in the drawings and described below provide techniques for encapsulating a trace packet using a footer data section, as well as establishing a link between a load/store instruction and its associated data trace packet using a pool of indices. By using a footer in the trace packet encapsulation, trace packets can be more efficiently retrieved from a trace memory circuit or buffer without the need for a delimiter to be written to the memory circuit or buffer at the beginning of a trace recording. The link established between a load/store instruction and its associated data trace packet can prevent erroneous decode and analysis of the trace packets.

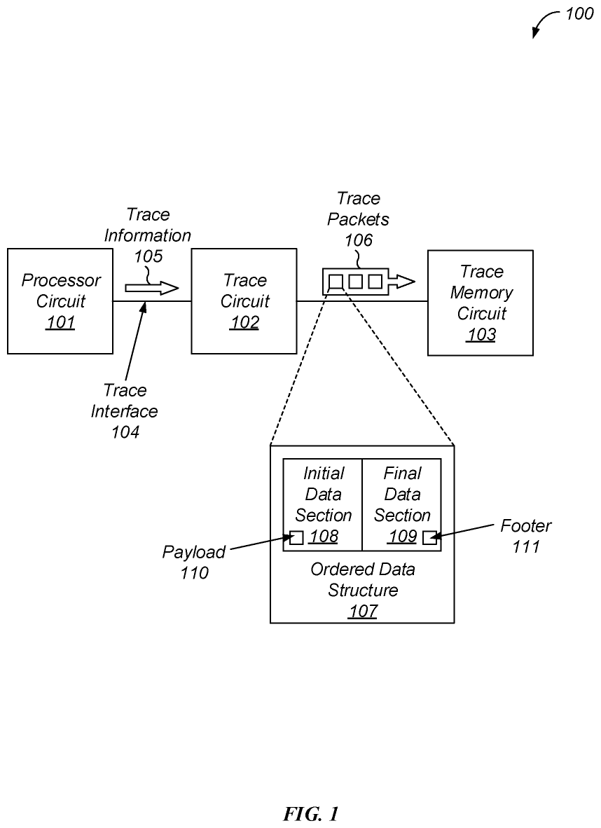

A block diagram of a processor trace system is depicted in FIG. 1. As illustrated, processor trace system 100 includes processor circuit 101, trace circuit 102, and trace memory circuit 103.

Processor circuit 101 is coupled to trace circuit 102 via trace interface 104. In various embodiments, processor circuit 101 is configured to generate trace information 105 in response to the activation of a trace operation. In various embodiments, the activation of the trace operation may be in response to execution of a particular software program or in response to a user request. In some cases, the trace operation may be triggered at regular intervals.

Trace circuit 102 is configured to receive trace information 105 from processor circuit 101 via trace interface 104. In various embodiments, trace circuit 102 is further configured to generate trace packets 106 using trace information 105. In some embodiments, a given trace packet of trace packets 106 includes data sections 108 and 109 arranged in ordered data structure 107. As used herein, an ordered data structure refers to a collection of data sections that have an explicit order to them, where a given data section in an ordered data structure can be considered to be “before” or “after” another data section of the ordered data structure. Such ordered data structures include at least an “initial” data section and a “final” data section.

In various embodiments, ordered data structure 107 includes initial data section 108 and final data section 109. Initial data section 108 can include payload 110 which, as described below, may include information corresponding to portions of trace information 105 associated to a given command or information retrieved as a result of the execution of a load/store command. Final data section 109 can include footer 111 which, as described below, may contain information indicative of a length of the given trace packet.

Trace memory circuit 103 is configured to store trace packets 106. In various embodiments, to store trace packets 106, trace memory circuit 103 may store a given trace packet of trace packets 106 at a location specified by a pointer that is incremented after each trace packet is stored. In cases where a number of trace packets 106 exceeds a number of storage locations in trace memory circuit 103, previously stored trace packets may be overwritten as the pointer wraps from a final address of trace memory circuit 103 to an initial address of trace memory circuit 103.

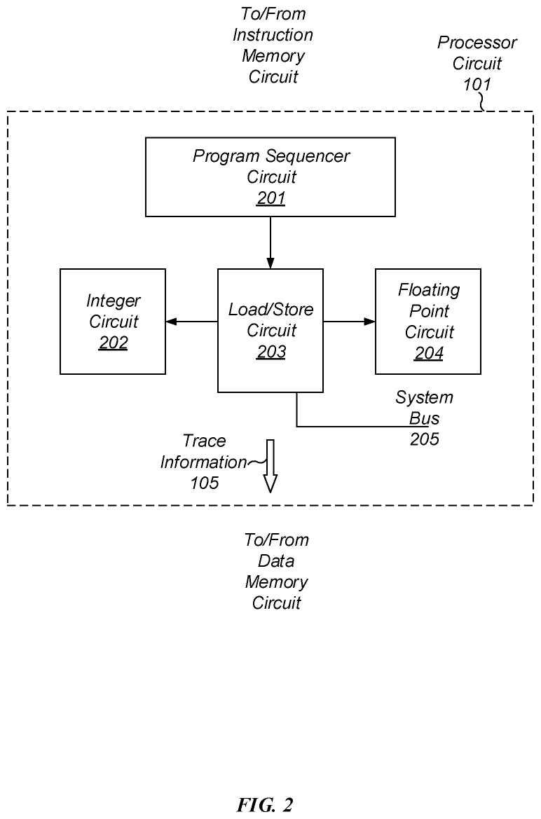

Referring to FIG. 2, a block diagram of an embodiment of processor circuit 101 is depicted. As illustrated, processor circuit 101 includes program sequencer circuit 201, integer circuit 202, load/store circuit 203, and floating-point circuit 204. In various embodiments, processor circuit 101 may correspond to a processor core that can be coupled to other processor cores to form a compute complex. In such cases, data can be exchanged between cores using system bus 205.

Program sequencer circuit 201 is configured to retrieve, on a per-cycle basis, a program or software instruction from an instruction memory circuit in a process referred to as “fetching an instruction.” In various embodiments, program sequencer circuit 201 may be configured to retrieve the program or software instruction across a multi-bit bus (e.g., 32-bits). Upon retrieving a particular instruction, program sequencer circuit 201 may be configured to decode the particular instruction and, based on results of the decode, route the particular instruction to one of integer circuit 202, load/store circuit 203, or floating-point circuit 204.

Integer circuit 202 is configured to receive arithmetic instructions from program sequencer circuit 201. In response to receiving a given arithmetic instruction from program sequencer circuit 201, integer circuit 202 is also configured to perform an arithmetic operation, or an integer multiply and divide operation based on the given arithmetic instruction. In various embodiments, integer circuit 202 may be further configured to perform various logic (e.g., an exclusive-OR operation) and bit manipulation operations (e.g., a shift-left operation).

Load/Store circuit 203 is configured to load data from a data memory circuit or system bus 205 in response to receiving a load instruction from program sequencer circuit 201. Additionally, load/store circuit 203 may be further configured to store data to the data memory circuit or system bus 205 in response to receiving a store instruction from program sequencer circuit 201.

Floating-point circuit 204 may include multiple pipelines configured to perform various floating-point arithmetic operations according to an instruction received from program sequencer circuit 201. In some embodiments, floating-point circuit 204 may be configured to perform single-cycle instructions using a single-cycle pipeline. Floating-point circuit 204 may be further configured to perform various multi-cycle instructions (e.g., floating-point add, square root, etc.) using multi-cycle pipelines. In some embodiments, floating-point circuit 204 may be further configured to perform logarithmic, exponential, and other transcendental operations. In various embodiments, trace interface 104 may gather various information from load/store circuit 203 to generate trace information 105.

It is noted that processor circuit 101 may include other circuit blocks which have been omitted from the embodiment of FIG. 2 for clarity.

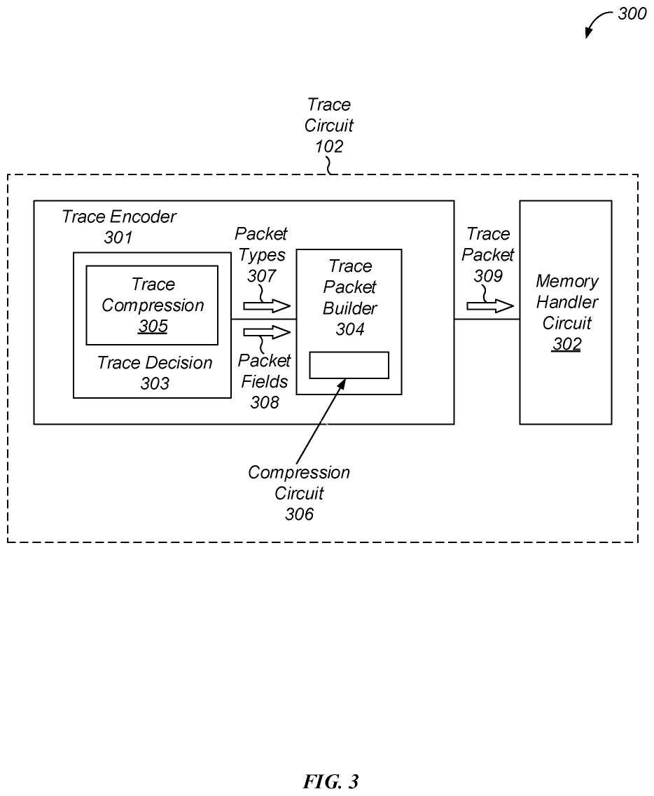

Turning to FIG. 3, a block diagram of an embodiment of trace circuit 102 is depicted. As illustrated, trace circuit 102 includes trace encoder 301 and memory handler circuit 302. Trace encoder 301 includes trace decision circuit 303 and trace packet builder 304.

Trace decision circuit 303 is configured to generate packet types 307 and packet fields 308 using trace information 105 to generate trace packet 309. In various embodiments, trace packet 309 may be included in trace packets 106. In some embodiments, packet types 307 may specify different packet types (e.g., data index trace packet) based on different types of information found in trace information 105. Packet fields 308 may include data for the payload, footer, and optional timestamp for a given one of trace packets 106.

Trace decision circuit 303 includes trace compression circuit 305. In various embodiments, trace compression circuit 305 is configured to compress portions of trace information 105 using a selected one of multiple compression modes to generate packet fields 308. For example, in some cases, trace compression circuit 305 may be configured to encode program counter discontinuities as a difference in address values instead of absolute addresses.

Trace packet builder 304 is configured to generate trace packet 309 using packet types 307 and packet fields 308. In various embodiments, trace packet builder 304 may be configured to generate and assemble different data sections (e.g., initial data section 108) according to a defined order. It is noted that although trace packet builder 304 is depicted as generating a single trace packet, in other embodiments, trace packet builder 304 is configured to generate any suitable number of trace packets.

In various embodiments, trace packet builder 304 includes compression circuit 306. In some cases, compression circuit 306 may be configured to compress assembled data sections for trace packet 309. For example, compression circuit 306 may be configured to eliminate identical bits from the most-significant end of trace packet 309, and adjust the length of the packet accordingly.

Memory handler circuit 302 is configured to store trace packet 309 in trace memory circuit 103. In various embodiments, memory handler circuit 302 may be configured to generate any commands needed for trace memory circuit 103 to write trace packet 309 into trace memory circuit 103. In some embodiments, memory handler circuit 302 may include a buffer circuit to store other trace packets from trace encoder 301 while the writing of trace packet 309 into trace memory circuit 103 is being completed. Memory handler circuit 302 may, in various embodiments, be implemented using a microcontroller, a state machine, or any other suitable sequential logic circuit.

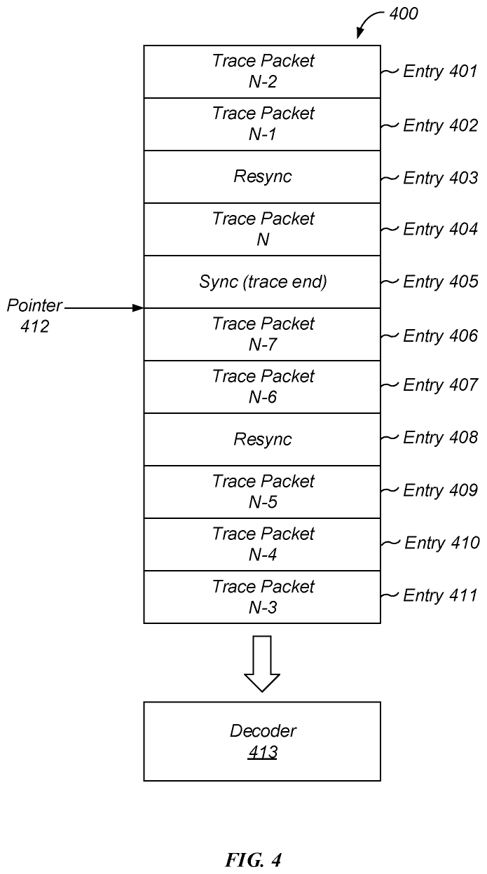

Turning to FIG. 4, a block diagram of an embodiment of how trace packets are stored in a trace memory circuit is depicted. As illustrated, memory circuit 400 includes eleven entries labeled, entries 401-411.

In the embodiment of FIG. 4, trace packets are written to memory circuit 400 using a wrap-around mode. When wrap-around mode is employed, trace circuit 102 will, in response to a determination that memory circuit 400 is full, continue writing trace packets starting from the beginning of the address space of memory circuit 400, overwriting previously stored trace packets. In various embodiments, memory circuit 400 may correspond to trace memory circuit 103 as depicted in the embodiment of FIG. 1. It is noted that, in some cases, a trace packet may be across the address space resulting in a first portion of the trace packet being stored at the bottom of memory circuit 400, and a second portion of the trace packet being stored at the top of memory circuit 400.

As illustrated, trace packet N-2 is stored in entry 401, while trace packet N-1 is stored in entry 402, where N is a positive integer denoting the number of trace packets in a given trace. A resync packet is stored in entry 403, followed by trace packet N, which is stored in entry 405. A sync trace packet that marks the end of a trace is stored in entry 405, and trace packet N-7 is stored in entry 406. Trace packet N-6 is stored in entry 407, and another resync packet is stored in entry 408. Trace packet N-5 is stored in entry 409, and trace packets N-4 and N-3 are stored in entries 410 and 411, respectively.

When the trace packets are read from memory circuit 400, decoder 413 starts reading memory circuit 400 from the position of pointer 412 and works backwards towards the start of memory circuit 400. As each trace packet is read, information in the footer data sections of the trace packets is used to determine a position within memory circuit 400 of the previous trace packet. The process of reading the trace packets continues until the start of the address space of memory circuit 400 is reached. In the illustrated embodiment, the start of the address space corresponds to entry 401, where trace packet N-2 is stored.

Since memory circuit 400 is operating in wrap-around mode, after the start of the address space is reached, decoder 413 wraps around to the end of the address space of memory circuit 400 and continues the process of determining trace packet locations until the oldest trace packet is encountered. In the illustrated embodiment, the oldest trace packet corresponds to trace packet N-7 and is stored in entry 406.

Once all of the positions of the trace packets have been determined, decoder 413 begins a forward pass through the stored trace packets starting with the oldest packet (e.g., trace packet N-7) until a resync packet is encountered (e.g., the resync packet stored in entry 408). It is noted that in some embodiments, a packet can be partially overwritten which can result in a gap between the oldest complete packet and the pointer. The resync packets provides a reference for decoder 413 to synchronize with off-line code. After the synchronization, decoder 413 continues working forward, wrapping around at the end of the address space of memory circuit 400. The process continues until the location of pointer 412 is reached. Once all of the trace data has been retrieved from memory circuit 400, any suitable analysis of the trace data may be employed.

In various embodiments, decoder 413 may be implemented as a general-purpose processor configured to execute software or program instructions. Alternatively, decoder 413 may be implemented as any suitable combination of sequential and combinatorial logic circuits configured to perform a desired decoding operation.

It is noted that although only eleven entries are depicted in the embodiment of FIG. 4, in other embodiments, any suitable number of entries may be employed. It is further noted that the storage scheme depicted in the embodiment of FIG. 4 is merely an example and that, in other embodiments, different storage schemes may be employed.

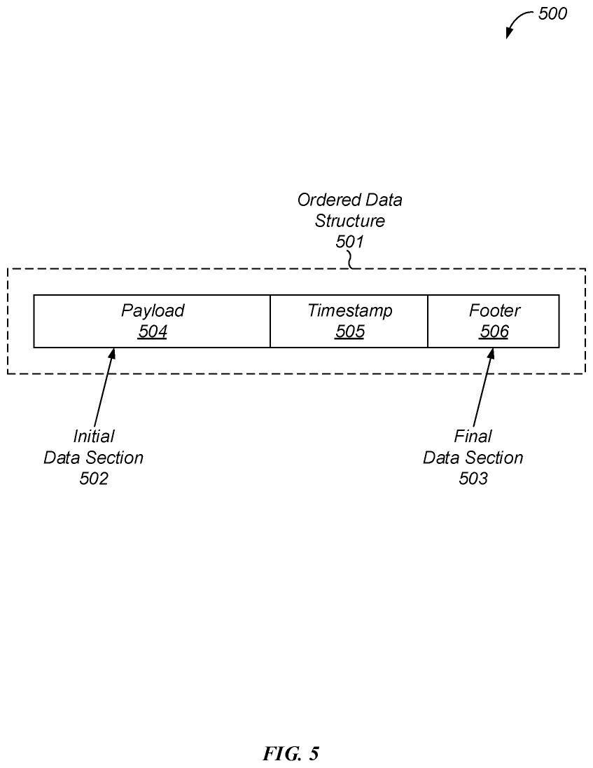

Turning to FIG. 5, a block diagram of an embodiment of a trace packet is depicted. As illustrated, trace packet 500 includes ordered data structure 501, which includes payload 504, timestamp 505, and footer 506. In various embodiments, trace packet 500 may correspond to any of trace packets 106 as depicted in FIG. 1.

As described above, a trace packet includes an ordered data structure of data sections. In the illustrated embodiment, initial data section 502 of ordered data structure 501 corresponds to payload 504, while final data section 503 corresponds to footer 506. Although only three data sections, i.e., payload 504, timestamp 505, and footer 506, are depicted in ordered data structure 501, in other embodiments, ordered data structure 501 may include any suitable number of data sections.

In various embodiments, payload 504 may include information corresponding to portions of trace information 105 associated with a given command or information retrieved as a result of the execution of a load/store command. In some cases, payload 504 may include information indicative of an executed instruction, address of associated registers, contents of associated registers, and the like.

Timestamp 505 may include information corresponding to an execution time for an instruction or command associated with trace packet 500. In some embodiments, timestamp 505 may include a value of a register that is incremented during each clock cycle of processor 101. It is noted that timestamp 505 is optional and that information encoded in footer 506 may indicate to a decoder whether or not timestamp 505 is included in trace packet 500.

Footer 506 may, in various embodiments, include information indicative of a total size (or “length”) of trace packet 500. In some cases, footer 506 may include additional information regarding additional data sections which may be included in trace packet 500. For example, in some embodiments, footer 506 may include information indicating the inclusion of timestamp 505 and which portion (e.g., bytes) of trace packet 500 corresponds to timestamp 505.

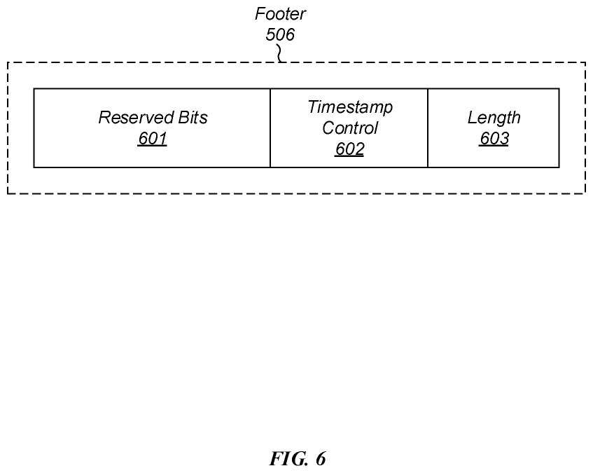

Referring to FIG. 6, a block diagram of footer 506 is depicted. As illustrated, footer 506 includes reserved bits 601, timestamp control 602, and length 603. Although only three fields are depicted as being included in footer 506 in the embodiment of FIG. 6, in other embodiments, any suitable number of fields may be employed.

In various embodiments, reserved bits 601 are set aside for other purposes. The number of bits included in reserved bits 601 may, in some embodiments, be based on a later intended use. It is noted that, in other embodiments, reserved bits 601 may not be reserved but rather used to encode some specific information.

Timestamp control 602 encodes information indicative of whether timestamp 505 has been included in trace packet 500. In various embodiments, timestamp control 602 may include a single bit whose value is indicative of whether or not timestamp 505 has been included in trace packet 500.

Length 603 may include one or more bits that encode a total size or length of trace packet 500. In some embodiments, length 603 may include a number corresponding to a number of bytes needed to represent the information included in trace packet 500. In other embodiments, length 603 may be encoded or compressed. As described above, length 603 may be used by a decoder (e.g., decoder 413) to work backwards through trace memory circuit 103 to locate a position of a proceeding trace packet.

Although footer 506 includes only three fields of information, in other embodiments, footer 506 may include any suitable number of fields.

To summarize, various embodiments of a trace circuit are disclosed. Broadly speaking, a processor circuit may be configured to generate trace information in response to an activation of a trace operation, and a trace circuit, coupled to the processor circuit via a trace interface, may be configured to receive the trace information. The trace circuit may be further configured to generate a plurality of trace packets including a given trace packet that includes an ordered data structure that includes a plurality of data sections, wherein an initial data section of the plurality of data sections includes a payload, and a final data section of the plurality of data sections includes a footer.

In other embodiments, the trace circuit may be configured, in response to a detection of a load/store instruction in the trace information, to assign a particular index to the load/store instruction from a pool of indices, and generate a data index trace packet using the particular index.

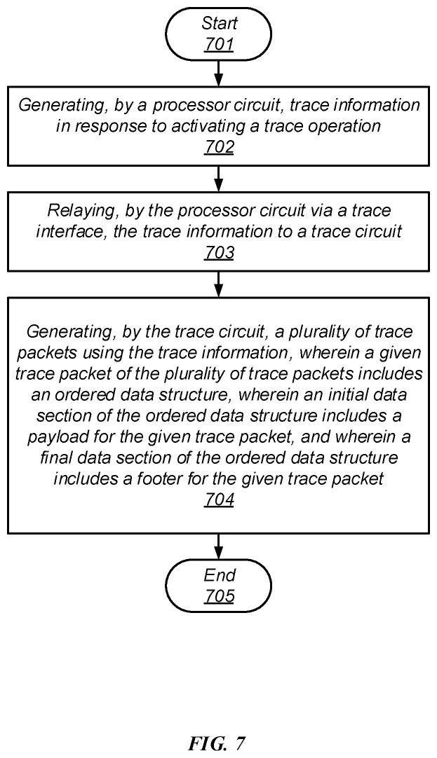

Turning to FIG. 7, a flow diagram of an embodiment of a method for performing a processor trace is depicted. The method, which may be applied to various trace circuits, e.g., trace circuit 102 as depicted in the embodiment of FIG. 1, begins in block 701.

The method includes generating, by a processor circuit, trace information in response to activating a trace operation (block 702). In various embodiments, the trace operation may be activated in response to execution of a particular software program or in response to a user request. In some cases, the trace operation may be triggered at regular intervals.

The method also includes relaying, by the processor circuit via a trace interface, the trace information to a trace circuit (block 703). In various embodiments, the trace interface may include a unidirectional interface that outputs the state of one or more signals, registers, and the like, from the processor circuit to the trace circuit without impacting the performance of the processor circuit. In various embodiments, the trace interface may allow the transmission of the type of instruction, the detection of an interrupt, an indication of whether a branch is taken or not taken, and the like.

The method further includes generating, by the trace circuit, a plurality of trace packets using the trace information, wherein a given trace packet of the plurality of trace packets includes an ordered data structure of data sections, wherein an initial data section of the ordered data structure of data sections includes a payload for the given trace packet, and wherein a final data section of the ordered data structure of data sections includes a footer for the given trace packet (block 704).

In some embodiments, the footer for the given trace packet may include information indicative of a length of the given trace packet. In other embodiments, generating a particular trace packet of the plurality of trace packets includes determining a packet type for the particular trace packet using the trace information, and determining a particular payload for the particular trace packet using the trace information. In some cases, the method may further include assembling the particular trace packet using the packet type and the particular payload, compressing the particular trace packet, and storing a compressed version of the particular trace packet in a memory circuit.

In various embodiments, the method may further include storing, by the trace circuit, the plurality of trace packets in the memory circuit. In some cases, storing a particular trace packet of the plurality of trace packets may include incrementing a trace pointer that contains information indicative of an address in the memory circuit to a most recently stored trace packet.

In other embodiments, the method may further include reading, by a decoder, a last trace packet of the plurality of trace packets stored in the memory circuit using the trace packet pointer. The method may also include determining, by the decoder, a location in the memory circuit of a proceeding trace packet using length information in the footer data section included in the last trace packet and, in response to identifying corresponding locations of the plurality of trace packets, decoding the plurality of trace packets starting with an initial trace packet of the plurality of trace packets using the corresponding locations. The method concludes in block 705.

### Data Trace Indexing

In some processor circuits, load and store instructions may access data bus out of order. This may, in some cases, be a result of weak memory ordering, or a result of load accesses overtaking store accesses. This out-of-order nature of the data bus access can create a challenge to a decoder processing trace packets to determine a link between load/store instructions and their corresponding data trace packets. As described below, the assignment of an index to a load/store instruction with an associated data trace packet can improve the ability to determine the link between the load/store instruction and its associated data trace packet during post-processing.

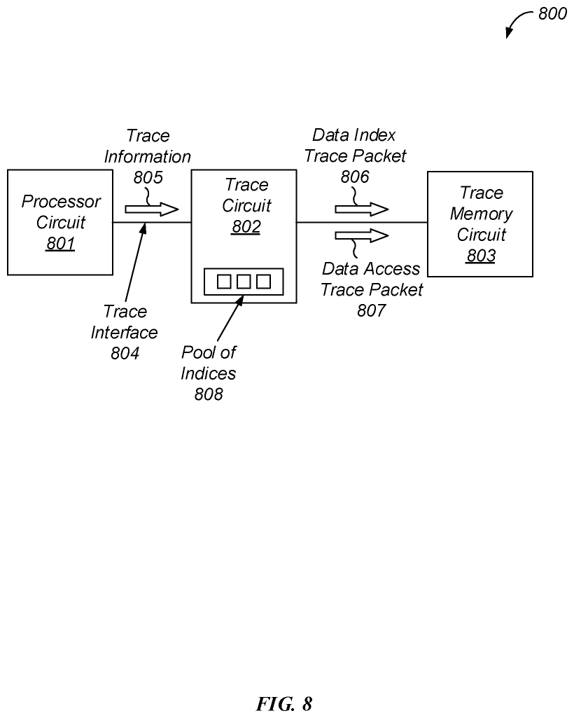

Turning to FIG. 8, a block diagram of another embodiment of a processor trace system is depicted. As illustrated, processor trace system 800 includes processor circuit 801, trace circuit 802, and trace memory circuit 803.

Processor circuit 801, which may correspond to processor circuit 101 in some embodiments, is coupled to trace circuit 802 via trace interface 804. In various embodiments, processor circuit 801 is configured to generate trace information 805 in response to an activation of a trace operation.

Processor circuit 801 may be implemented using a general-purpose processor circuit, or any other suitable processor circuit. In some cases, processor circuit 801 may include a single processor core while, in other embodiments, processor circuit 801 may include multiple processor cores. In some embodiments, processor circuit 801 may employ a reduced instruction set computer (“RISC”) architecture.

Trace circuit 802 is configured to receive trace information 805 via trace interface 804. In response to a detection of a load/store instruction in trace information 805, trace circuit 802 is further configured to assign a particular index from pool of indices 808, and generate data index trace packet 806 using the particular index. In some embodiments, trace circuit 802 may be further configured, in response to a detection of a bus access corresponding to the execution of the load/store instruction in trace information 805, generate data access trace packet 807 using the particular index.

In various embodiments, a number of indices in the pool of indices 808 may be based on a maximum number of outstanding transactions. Due to the out-of-order access, indices from pool of indices 808 may not be assigned in consecutive order, but rather on availability. For example index 0 may be assigned to a store operation that resides in a store buffer circuit, while many load operations over-take the store operation. In such cases, index 0 may not be released for re-assignment.

Trace circuit 802 may be configured to optionally filter trace packets. In various embodiments, the filtering is applied to data trace packets and does not affect instruction trace packets. In some embodiments, the filtering can be based on at least a virtual program counter value of a load/store instruction or a virtual address associated with the load/store instruction. Although only two criteria are described, it is possible and contemplated that other criteria may be employed. In some cases, load/store instructions that do not meet one or more of the filtering criteria may not have an index of the pool of indices 808 assigned.

In some embodiments, both data index trace packet 806 and data access trace packet 807 may include an ordered data structure of multiple data sections as described above. In various embodiments, both data index trace packet 806 and data access trace packet 807 may be compressed before being stored in trace memory circuit 803.

Trace memory circuit 803, which may, in various embodiments, correspond to trace memory circuit 103, is configured to store data index trace packet 806 and data access trace packet 807. In various embodiments, trace memory circuit 803 may maintain a pointer (e.g., pointer 412) that corresponds to a location of a most recently written trace packet. Although only two trace packets are depicted as being stored in trace memory circuit 803, in other embodiments, any suitable number of trace packets may be stored in trace memory circuit 803.

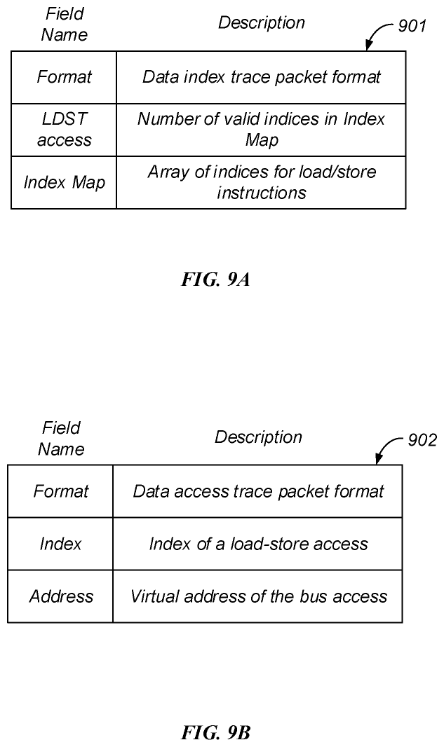

Referring to FIG. 9A, a table depicting an embodiment of a data index trace packet is depicted. In various embodiments, data index trace packet 806 may use the format specified in table 901. As illustrated, table 901 includes three fields: format, load/stored (“LDST”) access, and index map. In various embodiments, data corresponding to the three fields may be included in a payload for data index trace packet 806. It is noted that the format of the data index trace packet depicted in FIG. 9A is merely an example. In other embodiments, multiple different data index trace packet formats, that may include different numbers of fields, may be used in a processor trace system.

In various embodiments, the format field may include a number of bits that encode a format identifier. For example, the format field may include the binary value “00” which identifies the packet as a data index trace packet. In some cases, the format field may include the binary value “01”, which identifies the packet as an outstanding data indices packet.

The LDST access field includes a number of bits that encode a number of valid indices in the pool of indices 808. For example, a value of 0 can indicate there were no load/store instructions in a branch map, while a value of 31 can indicate that the branch map was full and only contained load-store instructions.

The index map field includes an array of indices for each load/store instruction in a branch map, ordered according to the load/store instruction. In various embodiments, branches are skipped.

Turning to FIG. 9B, a table depicting an embodiment of a data access trace packet is depicted. In various embodiments, data access trace packet 807 may use the format specified in table 902. As illustrated, table 902 includes three fields: format, index, and address. In various embodiments, data corresponding to the three fields may be included in a payload for data access trace packet 807. It is noted that the format of a data access trace packet depicted in FIG. 9B is merely an example. In other embodiments, multiple different data access trace packet formats, that may include different numbers of fields, may be used in a processor trace system.

In various embodiments, the format field may include a number of bits that encode a format identifier. For example, the format field may include the binary value “01” which identifies the packet as a data access trace packet.

The index field may include the value of the index assigned to the corresponding load/store instruction. It is noted that the number of bits used to represent the index may be programmable in some embodiments.

The address field may include a virtual address of the bus access. In such cases, the address field may including information indicative of the full virtual address. Alternatively, the address field may include information indicative of a difference (or “delta”) from a particular virtual address value.

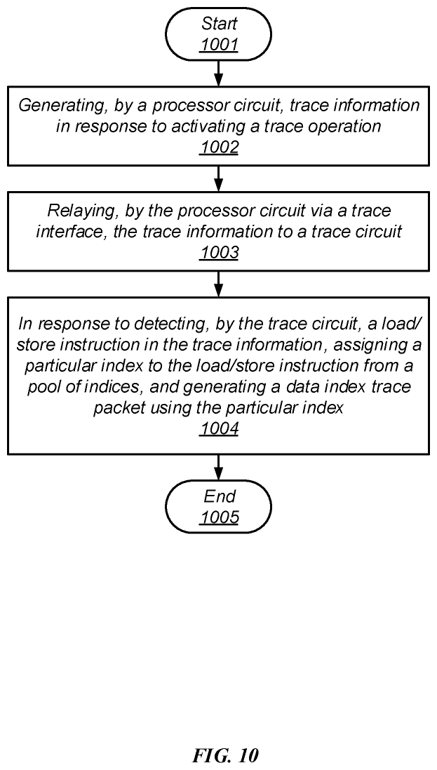

Turning to FIG. 10, a flow diagram depicting an embodiment of a method for linking data trace information and instruction trace information is illustrated. The method, which may be applied to various trace circuits (e.g., trace circuit 102 or trace circuit 802), begins in block 1001.

The method includes generating, by a processor circuit, trace information in response to activating a trace operation (block 1002). In various embodiments, the trace operation may be activated in response to execution of a particular software program or in response to a user request. In some cases, the trace operation may be triggered at regular intervals.

The method also includes relaying, by the processor circuit via a trace interface, the trace information to a trace circuit (block 1003). In various embodiments, the trace interface may include a unidirectional interface that outputs the state of one or more signals, registers, and the like, from the processor circuit to the trace circuit without impacting the performance of the processor circuit. In various embodiments, the trace interface may allow the transmission of the type of instruction, the detection of an interrupt, an indication of whether a branch is taken or not taken, and the like.

The method further includes, in response to detecting, by the trace circuit, a load/store instruction in the trace information, assigning a particular index to the load/store instruction from a pool of indices, and generating a data index trace packet using the particular index (block 1004). In some cases, assigning the particular index includes comparing the load/store instruction to at least one filter criterion. In other embodiments, generating the data index trace packet includes compressing the data index trace packet.

In various embodiments, the method may further include, in response to detecting a bus access corresponding to the execution of the load/store instruction in the trace information, generating a data access trace packet using the particular index. By using the particular index in both the data index trace packet and the data access trace packet, the load/store instruction is linked with its corresponding data making post-processing of the trace data easier.

In other embodiments, the data index trace packet includes an ordered data structure of a plurality of data sections. The ordered data structure may include an initial data section of the plurality of data sections that includes a payload for the data index trace packet. Additionally, the ordered data structure may include a final data section of the plurality of data sections that includes a footer for the data trace index packet. In various embodiments, the data access trace packet may also include its own ordered data structure including its own payload and footer.

In some cases, the footer for the data index trace packet includes information indicative of a length of the data index trace packet, and the payload for the data index trace packet includes information indicative of the particular index. In some embodiments, the method includes storing the data index trace packet and the data access trace packet into a memory circuit. The method concludes in block 1005.

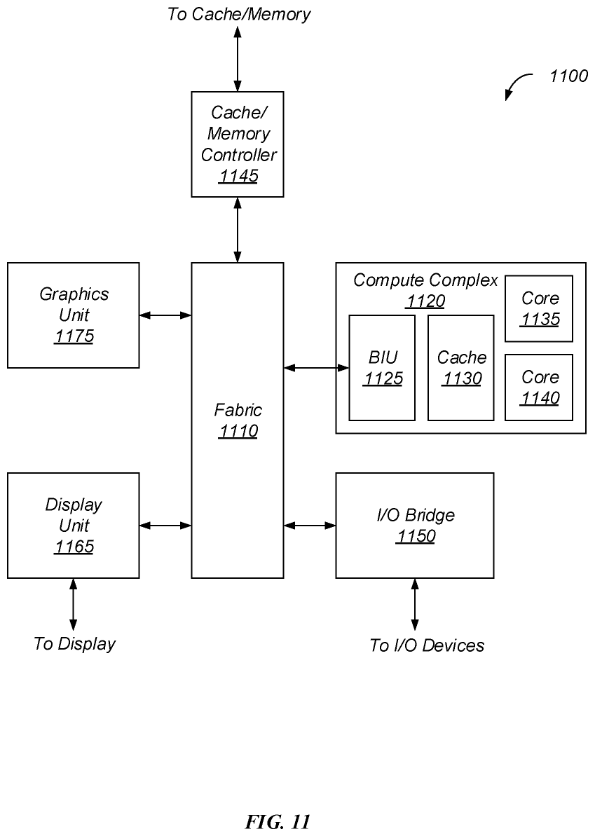

Referring now to FIG. 11, a block diagram illustrating an example embodiment of device 1100 is shown. In various embodiments, device 1100 may implement functionality of trace circuit 102 as depicted in FIG. 1. In some embodiments, elements of device 1100 may be included within a system on a chip. In some embodiments, device 1100 may be included in a mobile device, which may be battery-powered. Therefore, power consumption by device 1100 may be an important design consideration. In the illustrated embodiment, device 1100 includes fabric 1110, compute complex 1120, input/output (I/O) bridge 1150, cache/memory controller 1145, graphics unit 1175, and display unit 1165. In some embodiments, device 1100 may include other components (not shown) in addition to, or in place of, the illustrated components, such as video processor encoders and decoders, image processing or recognition elements, computer vision elements, etc.

Fabric 1110 may include various interconnects, buses, MUX's, controllers, etc., and may be configured to facilitate communication between various elements of device 1100. In some embodiments, portions of fabric 1110 may be configured to implement various different communication protocols. In other embodiments, fabric 1110 may implement a single communication protocol, and elements coupled to fabric 1110 may convert from the single communication protocol to other communication protocols internally.

In the illustrated embodiment, compute complex 1120 includes bus interface unit (BIU) 1125, cache 1130, and cores 1135 and 1140. In various embodiments, compute complex 1120 may include various numbers of processors, processor cores, and caches. For example, compute complex 1120 may include 1, 2, or 4 processor cores, or any other suitable number. In one embodiment, cache 1130 is a set associative L2 cache. In some embodiments, cores 1135 and 1140 may include internal instruction and data caches. In some embodiments, a coherency unit (not shown) in fabric 1110, cache 1130, or elsewhere in device 1100 may be configured to maintain coherency between various caches of device 1100. BIU 1125 may be configured to manage communication between compute complex 1120 and other elements of device 1100. Processor cores such as cores 1135 and 1140 may be configured to execute instructions of a particular instruction set architecture (ISA) which may include operating system instructions and user application instructions. These instructions may be stored in a computer readable medium such as a memory coupled to cache memory controller 1145 discussed below.

As used herein, the term “coupled to” may indicate one or more connections between elements, and a coupling may include intervening elements. For example, in FIG. 11, graphics unit 1175 may be described as “coupled to” a memory through fabric 1110 and cache/memory controller 1145. In contrast, in the illustrated embodiment of FIG. 11, graphics unit 1175 is “directly coupled” to fabric 1110 because there are no intervening elements.

Cache/memory controller 1145 may be configured to manage transfer of data between fabric 1110 and one or more caches and memories. For example, cache/memory controller 1145 may be coupled to an L3 cache, which may, in turn, be coupled to a system memory. In other embodiments, cache/memory controller 1145 may be directly coupled to a memory. In some embodiments, cache/memory controller 1145 may include one or more internal caches. Memory coupled to cache/memory controller 1145 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 1145 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1120 to cause the computing device to perform functionality described herein.

Graphics unit 1175 may include one or more processors, e.g., one or more graphics processing units (GPUs). Graphics unit 1175 may receive graphics-oriented instructions, such as OPENGL®, Metal®, or DIRECT3D® instructions, for example. Graphics unit 1175 may execute specialized GPU instructions or perform other operations based on the received graphics-oriented instructions. Graphics unit 1175 may generally be configured to process large blocks of data in parallel, and may build images in a frame buffer for output to a display, which may be included in the device or may be a separate device. Graphics unit 1175 may include transform, lighting, triangle, and rendering engines in one or more graphics processing pipelines. Graphics unit 1175 may output pixel information for display images. Graphics unit 1175, in various embodiments, may include programmable shader circuitry which may include highly parallel execution cores configured to execute graphics programs, which may include pixel tasks, vertex tasks, and compute tasks (which may or may not be graphics-related).

Display unit 1165 may be configured to read data from a frame buffer and provide a stream of pixel values for display. Display unit 1165 may be configured as a display pipeline in some embodiments. Additionally, display unit 1165 may be configured to blend multiple frames to produce an output frame. Further, display unit 1165 may include one or more interfaces (e.g., MIPI® or embedded display port (eDP)) for coupling to a user display (e.g., a touchscreen or an external display).

I/O bridge 1150 may include various elements configured to implement: universal serial bus (USB) communications, security, audio, and low-power always-on functionality, for example. I/O bridge 1150 may also include interfaces such as pulse-width modulation (PWM), general-purpose input/output (GPIO), serial peripheral interface (SPI), and inter-integrated circuit (I2C), for example. Various types of peripherals and devices may be coupled to device 1100 via I/O bridge 1150.

In some embodiments, device 1100 includes network interface circuitry (not explicitly shown), which may be connected to fabric 1110 or I/O bridge 1150. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1100 with connectivity to various types of other devices and networks.

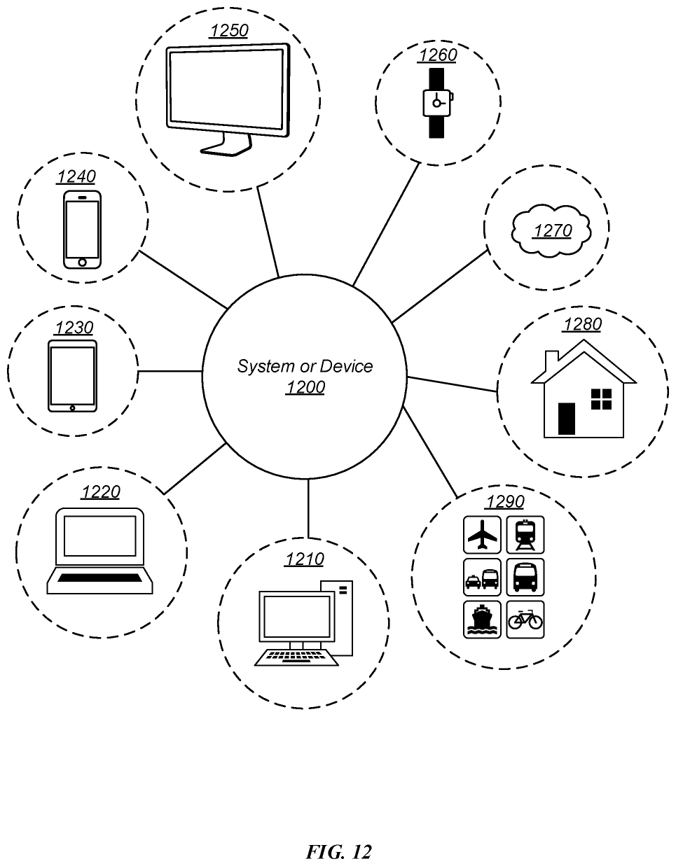

Turning now to FIG. 12, various types of systems that may include any of the circuits, devices, or systems discussed above are illustrated. System or device 1200, which may incorporate or otherwise utilize one or more of the techniques described herein, may be utilized in a wide range of areas. For example, system or device 1200 may be utilized as part of the hardware of systems such as a desktop computer 1210, laptop computer 1220, tablet computer 1230, cellular or mobile phone 1240, or television 1250 (or set-top box coupled to a television).

Similarly, disclosed elements may be utilized in a wearable device 1260, such as a smartwatch or a health-monitoring device. Smartwatches, in many embodiments, may implement a variety of different functions-for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1200 may also be used in various other contexts. For example, system or device 1200 may be utilized in the context of a server computer system, such as a dedicated server or on shared hardware that implements a cloud-based service 1270. Still further, system or device 1200 may be implemented in a wide range of specialized everyday devices, including devices 1280 commonly found in the home such as refrigerators, thermostats, security cameras, etc. The interconnection of such devices is often referred to as the “Internet of Things” (IoT). Elements may also be implemented in various modes of transportation. For example, system or device 1200 could be employed in the control systems, guidance systems, entertainment systems, etc. of various types of vehicles 1290.

The applications illustrated in FIG. 12 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

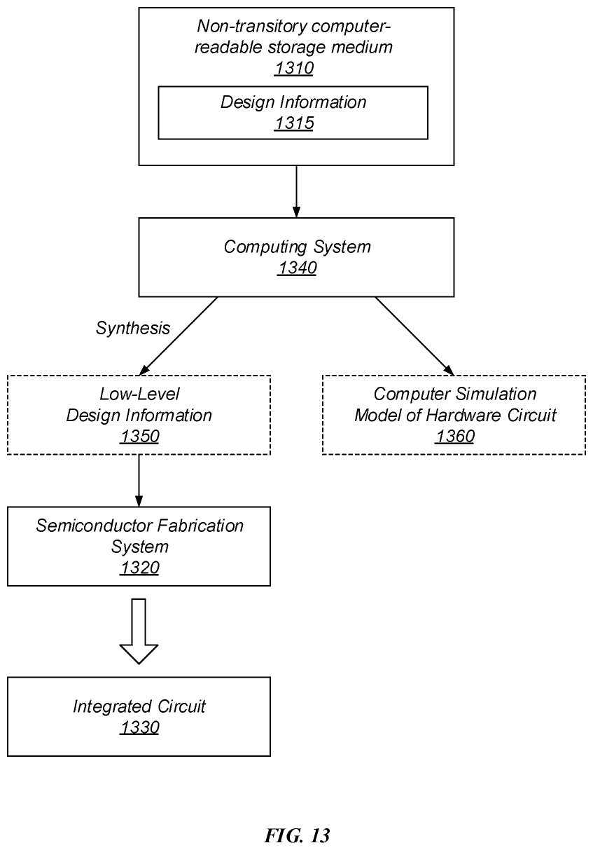

FIG. 13 is a block diagram illustrating an example of a non-transitory computer-readable storage medium that stores design information 1315, according to some embodiments. In the illustrated embodiment, computing system 1340 is configured to process design information 1315. This may include executing instructions included in design information 1315, interpreting instructions included in design information 1315, compiling, transforming, or otherwise updating design information 1315, etc. Therefore, design information 1315 controls computing system 1340 (e.g., by programming computing system 1340) to perform various operations discussed below, in some embodiments.

In the illustrated example, computing system 1340 processes design information 1315 to generate both computer simulation model of hardware circuit 1360 and low-level design information 1350. In other embodiments, computing system 1340 may generate only one of these outputs, may generate other outputs based on design information 1315, or both. Regarding computer simulation model 1360, computing system 1340 may execute instructions of a hardware description language that includes register transfer level (RTL) code, behavioral code, structural code, or some combination thereof. The simulation model may perform the functionality specified by design information 1315, facilitate verification of the functional correctness of the hardware design, generate power consumption estimates, generate timing estimates, etc.

In the illustrated example, computing system 1340 also processes design information 1315 to generate low-level design information 1350 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1350 (potentially among other inputs), semiconductor fabrication system 1320 is configured to fabricate integrated circuit 1330 (which may correspond to functionality of computer simulation model of hardware circuit 1360). Note that computing system 1340 may generate different simulation models based on design information at various levels of description, including low-level design information 1350, design information 1315, and so on. The data representing low-level design information 1350 and computer simulation model 1360 may be stored on non-transitory computer readable storage medium 1310, or on one or more other media.

In some embodiments, low-level design information 1350 controls (e.g., programs) semiconductor fabrication system 1320 to fabricate integrated circuit 1330. Thus, when processed by the fabrication system, the design information may program the fabrication system to fabricate a circuit that includes various circuitry disclosed herein.

Non-transitory computer-readable storage medium 1310 may comprise any of various appropriate types of memory devices or storage devices. Non-transitory computer-readable storage medium 1310 may be an installation medium, e.g., a CD-ROM, floppy disks, or a tape device; a computer system memory or random access memory such as DRAM, DDR RAM, SRAM, EDO RAM, Rambus RAM, etc.; a non-volatile memory such as a Flash memory circuit, magnetic media, e.g., a hard drive, or optical storage; registers, or other similar types of memory elements, etc. Non-transitory computer-readable storage medium 1310 may include other types of non-transitory memory as well or combinations thereof. Accordingly, non-transitory computer-readable storage medium 1310 may include two or more memory media, which may reside in different locations—for example, in different computer systems that are connected over a network.

Design information 1315 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1340, semiconductor fabrication system 1320, or both. In some embodiments, design information 1315 may also include one or more cell libraries that specify the synthesis, layout, or both of integrated circuit 1330. In some embodiments, design information 1315 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated, but not their physical layout. In this case, design information may be combined with layout information to actually fabricate the specified circuitry.

Integrated circuit 1330 may, in various embodiments, include one or more custom macrocells, such as memories, analog or mixed-signal circuits, and the like. In such cases, design information 1315 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1320 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1320 may also be configured to perform various testing of fabricated circuits for correct operation.

In various embodiments, integrated circuit 1330 and computer simulation model 1360 are configured to operate according to a circuit design specified by design information 1315, which may include performing any of the functionality described herein. For example, integrated circuit 1330 may include any of various elements shown in FIGS. 1 and 8. Further, integrated circuit 1330 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1315. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1315 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1350. Low-level design information 1350 may program semiconductor fabrication system 1320 to fabricate integrated circuit 1330.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise.

Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a processor circuit configured to generate trace information in response to an activation of a trace operation; and
a trace circuit coupled to the process circuit via a trace interface, wherein the trace circuit is configured to:
receive the trace information from the processor circuit via the trace interface; and
generate a plurality of trace packets including a given trace packet that includes an ordered data structure that includes a plurality of data sections, wherein an initial data section of the plurality of data sections includes a payload, and a final data section of the plurality of data sections includes a footer.

2. The apparatus of claim 1, wherein the footer includes first information indicative of a length of the given trace packet.

3. The apparatus of claim 2, wherein the footer further includes second information indicative of a presence of timestamp information in a different data section of the ordered data structure of data sections, and wherein the timestamp information includes third information indicative of count value that is incremented during a given clock cycle of the processor circuit.

4. The apparatus of claim 1, further comprising a trace memory, and wherein the trace circuit is further configured to store the plurality of trace packets in the trace memory.

5. The apparatus of claim 1, wherein the trace circuit includes a trace decision circuit configured to generate a packet type identifier and packet field data using the trace information.

6. The apparatus of claim 5, wherein the trace circuit further includes a trace packet builder circuit configured to:
generate a given trace packet of the plurality of trace packets using the packet type identifier and the packet field data; and
compress the given trace packet.

7. A method, comprising:
generating, by a processor circuit, trace information in response to activating a trace operation;
relaying, by the processor circuit via a trace interface, the trace information to a trace circuit; and
generating, by the trace circuit, a plurality of trace packets using the trace information, wherein a given trace packet of the plurality of trace packets includes an ordered data structure of a plurality of data sections, wherein an initial data section of the plurality of data sections includes a payload for the given trace packet, and wherein a final data section of the plurality of data sections includes a footer for the given trace packet.

8. The method of claim 7, wherein the footer includes first information indicative of a length of the given trace packet.

9. The method of claim 8, further comprising storing, by the trace circuit, the plurality of trace packets in a memory circuit.

10. The method of claim 9, further comprising:
reading, by a decoder, a last trace packet of the plurality of trace packets stored in the memory circuit using a trace packet pointer;
determining, by the decoder, a location in the memory circuit of a preceding trace packet using length information included in a footer data section included in the last trace packet; and
in response to identifying corresponding locations of the plurality of trace packets, decoding the plurality of trace packets starting with an initial trace packet of the plurality of trace packets using the corresponding locations.

11. The method of claim 10, wherein generating a particular trace packet of the plurality of trace packets includes:
determining a packet type for the particular trace packet using the trace information; and
determining a particular payload for the particular trace packet using the trace information.

12. The method of claim 11, further comprising:
assembling the particular trace packet using the packet type and the particular payload;
compressing the particular trace packet; and
storing a compressed version of the particular trace packet in the memory circuit.

13. The method of claim 7, further comprising, in response to detecting a load/store instruction in the trace information, assigning an index from a pool of indices to the load/store instruction.

14. An apparatus, comprising:
a processor circuit configured to generate trace information in response to an activation of a trace operation; and
a trace circuit coupled to the processor circuit via a trace interface, wherein the trace circuit is configured to:
receive the trace information via the trace interface;
in response to a detection of a load/store instruction in the trace information:
assign a particular index to the load/store instruction from a pool of indices; and
generate a data index trace packet using the particular index.

15. The apparatus of claim 14, wherein the trace circuit is further configured, in response to detection of a bus access corresponding to an execution of the load/store instruction in the trace information, to generate a data access trace packet using the particular index.

16. The apparatus of claim 15, further comprising a memory circuit configured to store the data index trace packet and the data access trace packet.

17. The apparatus of claim 15, wherein to assign the particular index, the trace circuit is further configured to compare the load/store instruction to at least one filter criterion.

18. The apparatus of claim 14, wherein the data index trace packet includes an ordered data structure of a plurality of data sections, wherein an initial data section of the plurality of data sections includes a payload for the data trace index packet, and wherein a final data section of the plurality of data sections includes a footer for the data trace index packet.

19. The apparatus of claim 18, wherein the footer includes first information indicative of a length of the data index trace packet, and wherein the payload includes second information indicative of the particular index.

20. The apparatus of claim 14, wherein to generate the data index trace packet, the trace circuit is further configured to compress the data index trace packet.
